(19) United States
(12) Patent Application Publication
(10) Pub. No.: US 2007/0262538 A1
(43) Pub. Date: Nov. 15, 2007

(54) Cylinder head gasket

(75) Inventor: Tomohito Taguchi, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: ISHIKAWA GASKET CO., LTD, Tokyo (JP)

(21) Appl. No.: 11/797,690

(22) Filed: May 7, 2007

(30) Foreign Application Priority Data
May 12, 2006 (JP) 2006-134259

(51) Int. Cl. F02F 11/00

(52) U.S. Cl. 277/598

(57) ABSTRACT

A cylinder head gasket includes at least one gasket plate having a fluid hole therein, and a rubber ring plate laminated on the gasket plate at the fluid hole and having a rubber ring for sealing at a periphery of a communicating hole corresponding to the fluid hole. A projection is provided on one of the gasket plate and the ring plate to project toward the other plate, and an engaging hole is provided in the other of the gasket plate and the ring plate for engaging the projection. Thus, the rubber ring plate is positioned with respect to the gasket plate in an irrotational state.

### BACKGROUND OF THE INVENTION AND RELATED ART STATEMENT

The present invention relates to a cylinder head gasket disposed between a cylinder block and a cylinder head of an engine.

This type of cylinder head gasket is generally provided with a plurality of fluid holes for corresponding to water holes, oil holes, and the like, formed in a cylinder block. Cooling water and oil circulate through the water holes and the oil holes while passing through the fluid holes. The water holes and the oil holes are sealed by the cylinder head gasket disposed between a cylinder block and a cylinder head. However, a sealing ability of specific water hole or oil hole is required to be further improved according to the condition.

In this case, for example, the technique described in Japanese Patent Publication No. 11-264473 can be applied, and a rubber ring plate provided with a rubber ring for sealing may be disposed at the fluid hole of the gasket which is required to be sealed.

However, in such a case where the rubber ring plate is provided in the gasket, generally another fluid holes are closely provided, or a plate forming the gasket or other members are closely disposed around the fluid holes described above. Accordingly, the rubber ring plate is required to be reliably disposed in the correct direction in an irrotational state in such a way that the rubber ring plate does not mutually interfere with the fluid holes and the other members. Especially, in a case that the rubber ring plate is formed in non-circular shape and has directionality, the other fluid holes may be closed, or the rubber ring plate may be mutually overlapped with other plate due to a misalignment of amounting direction of the rubber ring plate, thereby causing problems. Therefore, the attachment of the rubber ring plate is required to be placed precisely.

A technical object of the present invention is, in the cylinder head gasket, to attach a rubber ring plate provided with a rubber ring for sealing to a position of a-fluid hole required to be sealed in the correct direction with an irrotational state.

Further objects and advantages of the invention will be apparent from the following description of the invention.

### SUMMARY OF THE INVENTION

In order to achieve the object described above, according to the present invention, a cylinder head gasket includes at least one fluid hole having a periphery to be sealed. The cylinder head gasket includes at least one gasket plate having the fluid hole, and a rubber ring plate overlapped with the gasket plate at a position of the fluid hole and having a rubber ring for sealing at a periphery of a communicating hole corresponding to the fluid hole. One of the gasket plate and the rubber ring plate is provided with a projection projecting toward the other plate, and the other plate is provided with an engaging hole for engaging the projection. Therefore, the rubber ring plate is positioned with respect to the gasket plate and fixed in an irrotational state.

Also, the projection may be a bead formed on the gasket plate, and the engaging hole may be provided on the rubber ring plate.

In addition, the projection may be formed of a rubber material and projects toward the rubber ring plate, and the engaging hole may be provided on the gasket plate.

According to the present invention, it is preferred that the projection is formed in a shape wherein a diameter at an end portion thereof is increased from that at a base end portion thereof, and the engaging hole is formed to have a diameter at an outer end thereof located opposite to an inner end thereof larger than that at the inner end.

More preferably, the cylinder head gasket according to the present invention includes first and second gasket plates disposed at both sides of the rubber ring plate, and a middle plate disposed between the first and second gasket plates without overlapping with the rubber ring plate. A height of the projection is formed smaller than a thickness of the middle plate.

The cylinder head gasket according to the present invention may be attached at the position of the fluid hole to be sealed in a state that the rubber ring plate is positioned in the correct direction with the irrotational state.

### BRIEF DESCRIPTION OF THE DRAWINGS

FIG. 1 is a partial plan view showing a first embodiment of a cylinder head gasket according to the present invention;

FIG. 2 is a sectional view showing a main portion in the first embodiment;

FIG. 3 a plan view showing a rubber ring plate in the first embodiment;

FIG. 4 is a sectional view showing a main portion in a second embodiment according to the present invention; and

FIG. 5 is a sectional view showing a main portion in a third embodiment according to the present invention.

### DETAILED DESCRIPTION OF PREFERRED EMBODIMENTS

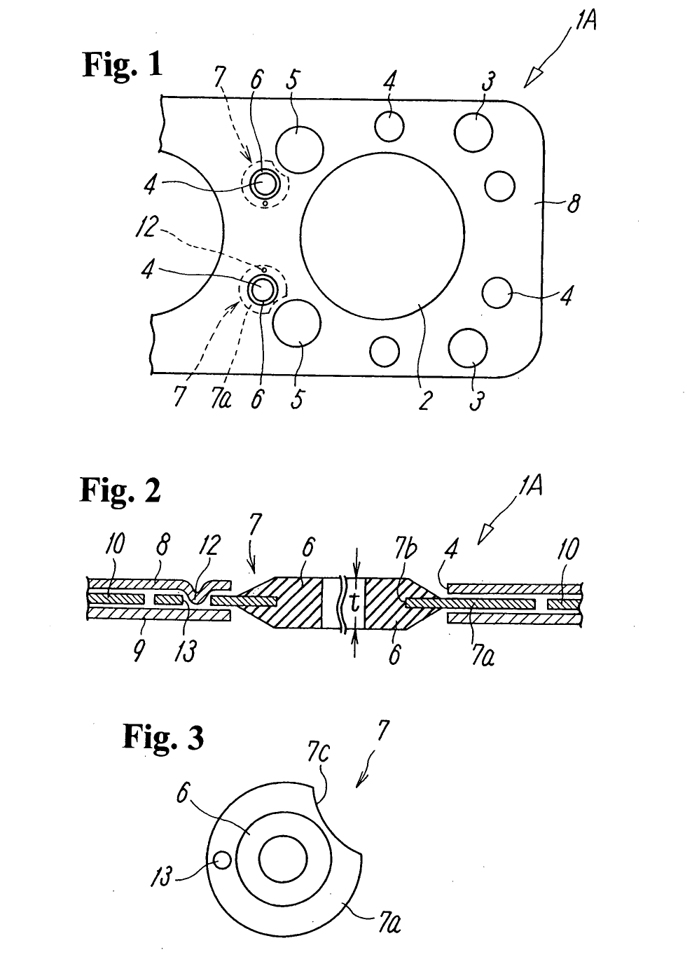

FIGS. 1 and 2 show a first embodiment of a cylinder head gasket according to the present invention. A cylinder head gasket 1A is arranged between a cylinder head and a cylinder block for sealing surfaces thereof. The cylinder head gasket 1 A includes combustion chamber holes 2 corresponding to combustion chambers, bolt holes 3 for inserting bolts to fasten the cylinder head and the cylinder block, and fluid holes such as water holes 4 for passing engine cooling water and oil holes 5 for passing oil.

The cylinder head gasket 1A includes first and second gasket plates 8 and 9 located at upper and lower surfaces and having almost the same sizes and shapes, a middle plate 10 disposed between the first and the second gasket plates 8 and 9 for forming a sealing surface pressure at required positions of the cylinder head gasket 1A, and rubber ring plates 7 provided at fluid holes between the gasket plates 8 and 9. In the embodiment shown in the drawing, the rubber ring plates 7 are provided at so of the water holes 4.

The both gasket plates 8 and 9, and the middle plate 10 are formed of metal or other plate materials, and include the required number of the combustion chamber holes 2, the bolt holes 3, and the fluid holes such as the water holes 4 and the oil holes 5. Also, the rubber ring plate 7 generates a sealing surface pressure around the water holes 4.

As shown in FIG. 3, the rubber ring plate 7 includes a metal plate main portion 7a having a communicating hole 7b with a diameter smaller than a diameter of the water hole 4 provided at a position corresponding to the water hole 4, and an annular-shaped rubber ring 6 formed to project on the both surfaces of the metal plate main portion 7a at a periphery of the communicating hole 7b. The rubber ring 6 is formed of a heat-resisting rubber or synthetic resin, and arranged concentrically inside the water hole 4. The thickness of the rubber ring 6 t is larger than a total thickness of the gasket plates 8 and 9, and the middle plate 10.

On the other hand, the plate main portion 7a has an outline with a roughly circular shape as shown in FIG. 3. However, a notch portion 7c is formed along a shape of each oil hole 5 at an outer periphery of the plate main portion 7a corresponding to the oil hole 5 so that the plate main portion 7a does not cover the oil hole 5 adjacent to the water hole 4. In fact, the plate main portion 7a has the outline with a noncircular shape due to the notch portion 7c. The outline or shape of the plate main portion 7a may be formed in other proper shape such as a rectangle or oval or the like. Also, the thickness of the plate main member 7a is required to be the same as or thinner than the thickness of the middle plate 10.

In order to properly arrange the rubber ring plate 7 at a position of the water hole 4 in the correct direction, a projection 12, projecting toward the rubber ring plate 7, is formed at a position of the first gasket plate 8 overlapped with the rubber ring plate 7. On the other hand, an engaging hole 13 is formed in order to engage with the projection 12 in the rubber ring plate 7, and the rubber ring plate 7 is fixed and properly positioned in an irrotational state and in a required direction due to the engagement of the projection 12 with the engaging hole 13.

The projection 12 is a bead which is a part of the gasket plate 8 deformed to project toward the rubber ring plate 7. The projection 12 is formed in a cylindrical shape with a tapered edge, and has a height within the thickness of the plate main portion 7a or the middle plate 10 so that the projection 12 does not generate an unnecessary surface pressure.

In the cylinder head gasket 1A having the structure described above, the projection 12 provided in the first gasket plate 8 engages the engaging hole 13 provided in the rubber ring plate 7. Accordingly, even if the rubber ring plate 7 is formed in a noncircular shape with directionality, the rubber ring plate 7 is positioned in the correct direction and fixed in the irrotational state so that the rubber ring plate 7 does not rotate due to an external force such as an engine vibration. As a result, it is possible to prevent problems such as the rubber ring plate 7 interferes with and covers the adjacent oil holes 5, or the rubber ring plate 7 is overlapped with the middle plate 10.

Also, the height of the projection 12 is formed to be the same as or less than the thickness of the middle plate 10 disposed between the first and second gasket plates 8 and 9. Therefore, the unnecessary surface pressure is not formed when the projection 12 contacts the second gasket plate 9.

In the cylinder head gasket 1A according to the embodiment as described above, the rubber ring plates 7 are disposed at some water holes 4 in the gasket plates 8 and 9. The rubber ring plates 7 may be disposed at some oil holes 5 instead of the water holes 4, or both of the water holes 4 and oil holes 5.

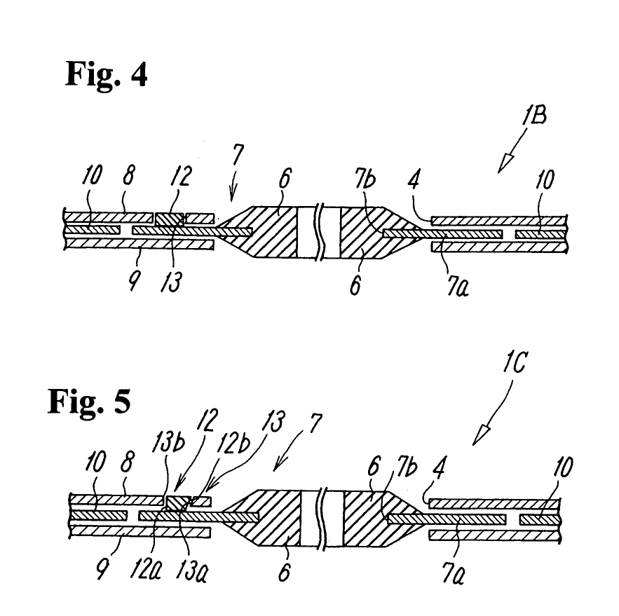

FIG. 4 shows a second embodiment of the present invention.

A cylinder head gasket 1B of the second embodiment is different in two points from the cylinder head gasket 1A of the first embodiment. One is the projection 12 formed in the rubber ring plate 7, and the other is the engaging hole 13 formed in the first gasket plate 8. The projection 12 formed in the rubber ring plate 7 is formed of a heat-resisting rubber material in a short cylindrical shape or short prismatic shape, and fixed on the plate main portion 7a with proper means such as an adhesive or the like. On the other hand, the engaging hole 13 is formed to have a circular or cylindrical vent shape having a uniform inner diameter all over the thickness of the gasket plate 8.

It is preferable that the projection 12 has the height within the thickness of the first gasket plate 8 so that the projection 12 does not protrude from the first gasket plate 8.

Substantially, the structures other than the structure described above in the second embodiment are the same as that in the first embodiment.

FIG. 5 shows a third embodiment of the present invention. Differences between a gasket 1C in the third embodiment and the gasket 1B in the second embodiment are: the rubber projection 12 provided on the rubber ring plate 7 is formed by a short columnar shape wherein a diameter is increased toward the end portion 12b from the base end portion 12a; and the engaging hole 13 formed in the first gasket plate 8 is formed in a shape wherein a bore diameter is increased toward the outer end 13b from the inner end 13a located opposite to the outer end 13b for inserting the projection 12 in accordance with the shape of the projection 12. Therefore, in the third embodiment, when the projection 12 is resiliently deformed with a compressive force to engage the engaging hole 13, the projection 12 engages the engaging hole 13, thereby preventing the disengagement. As a result, the rubber ring plate 7 is securely fixed even further.

In the embodiment shown in the drawings, side surfaces of the projection 12 and engaging hole 13 at a side of the water hole 4 are respectively inclined in an expanded-shape. However, the side surfaces of the projection 12 and engaging hole 13 at the other side may be inclined instead of the side of the water hole 4.

In the third embodiment, the other structures and effects are substantially same as those in the second embodiment. Therefore, the same symbols are placed at the same or equivalent parts, and the explanations are omitted.

The disclosure of Japanese Patent Application No. 2006-134259, filed on May 12, 2006, is incorporated as a reference.

While the invention has been explained with reference to the specific embodiments of the invention, the explanation is illustrative and the invention is limited only by the appended claims.

What is claimed is:

1. A cylinder head gasket comprising:
at least one gasket plate having a fluid hole therein,
a rubber ring plate laminated on the gasket plate at the fluid hole and having a rubber ring for sealing with a communicating hole corresponding to the fluid hole,
a projection provided on one of the gasket plate and the ring plate to project toward the other plate, and
an engaging hole provided in the other of the gasket plate and the ring plate for engaging the projection so that the rubber ring plate is positioned with respect to the gasket plate in an irrotational state.

2. A cylinder head gasket according to claim 1, wherein said projection is a bead formed on a gasket plate; and said engaging hole is provided on the rubber ring plate.

3. A cylinder head gasket according to claim 1, wherein said projection is formed of a rubber material and projects from the rubber ring plate, and said engaging hole is provided in the gasket plate.

4. A cylinder head gasket according to claim 3, wherein said projection has a diameter increasing from a base end portion thereof to an upper end portion, and said engaging hole has a bore diameter at an outer end larger than a bore diameter at an inner end located opposite to the outer end for inserting the projection.

5. A cylinder head gasket according to claim 1, wherein said at least one gasket plate comprises first and second gasket outer plates, and a middle plate disposed between the first and the second gasket plates, said rubber ring plate being sandwiched between the first and second gasket plates without overlapped with the middle plate, said projection having a height less than a thickness of the middle plate.

6. A cylinder head gasket according to claim 5, wherein said rubber ring plate comprises a metal plate, the rubber ring projecting from the metal plate and having a hole in a center thereof.

7. A cylinder head gasket according to claim 6, wherein said metal plate has a notch at one side thereof.
